(19) United States
(12) Patent Application Publication
(10) Pub. No.: US 2006/0170880 A1
(43) Pub. Date: Aug. 3, 2006

(54) Brightness and colour control of a projection appliance

(75) Inventors: Soren Dambach, Wohnsitz (DE); Harald Lang, Wohnsitz (DE)

Correspondence Address: VENABLE LLP, P.O. BOX 34385, WASHINGTON, DC, 20045-9998, US

(73) Assignee: BARCO CONTROL ROOMS GMBH, KARLSRUHE (DE)

(21) Appl. No.: 10/536,835

(22) PCT Filed: Dec. 3, 2003
(86) PCT No.: PCT/EP03/13629

§ 371 Date: Jan. 27, 2006

(30) Foreign Application Priority Data
Dec. 4, 2002 (DE) 102 56 505.8
Dec. 4, 2002 (DE) 102 56 503.1

(51) Int. Cl. G03B 21/14

(52) U.S. Cl. 353/84; 349/5; 353/85

(57) ABSTRACT

In order to control the brightness and/or the color of a projection apparatus (1), more particularly of a rear projection apparatus of a projection wall, wherein the image generation is based on time-sequential mixing of primary colors, it is proposed that a semi-transparent mirror (14) is used to couple out a portion of the light supplied to the imaging device (11), that a sensor (15) is used to measure said light portion and that the image generation is controlled with the signal thus obtained.

The invention relates to the brightness and color control of projection apparatuses. Projection apparatuses serve to project an image onto a projection screen. The invention concentrates on projection apparatuses which comprise an imaging device that can be controlled pixel by pixel and is provided for representing the image at a reduced scale, an illumination unit for illuminating the imaging device, and a projection assembly that comprises a projection lens and is provided for imaging the image represented by the imaging device enlarged onto the projection screen, wherein the illumination unit contains a time-variable color filter—referred to as dynamic color filter below—for generating primary colors, in order to implement time-sequential additive color mixing. In order to adjust the position of the image projected on the projection screen, the imaging device and/or the projection assembly is usually attached in or to the projection apparatus in a position that can be adjusted by means of alignment elements.

There are front and rear projection apparatuses. For example, front projectors and rear projection systems differ in that rear projection systems mostly contain further optical elements, such as deflecting mirrors and projection screens, which are not used in front projectors.

Both front and rear projection apparatuses serve to show an image on a large-size projection screen. Herein, the imaging device may be a transmitted-light imaging device, that is an imaging device which is transilluminated transmissively by an illumination assembly for illuminating the imaging device, or a reflecting imaging device which is illuminated by the illumination assembly. According to the prior art, use is, for example, made of transmitted-light liquid-crystal imaging devices or reflective polysilicon or liquid-crystal imaging devices or DMDs (trademark of Texas Instruments Inc., Digital Micromirror Device).

Usually, an illumination unit for illuminating the imaging device or for transilluminating the transmitted-light imaging device comprises a light source, a reflector and a condenser system with one or more condenser lenses for illuminating the imaging device. If a focusing, e.g. elliptical or even complexer lamp reflector is used, it is possible to do without the condenser system. Furthermore, additional condensers or light mixing systems, for example for optimum illumination of a rectangular image format, can be provided. The projection assembly or illumination unit is either integrated in or attached to the projection apparatus. Thus, a projection apparatus is a closed and complete unit for representing an image, wherein a screen for viewing the image is integrated in a rear projection apparatus.

Rear projection modules are, in particular, widely used whenever a complex image, for example consisting of various video or computer images, is to be shown on a large area. Prevalent fields of application for such rear projection apparatuses are projection walls which are viewed by a plurality of persons at the same time. Large-screen rear projection is widely used particularly in modern control station technology.

If the image to be shown is to exceed a specific size and complexity with given quality requirements, then this cannot be achieved with one single rear projection module any longer. In such cases, the image is composed of partial images each of which is shown by one rear projection module. In this case, each image shown by one rear projection module is a partial image of the overall image forming the projection wall and shown by all rear projection modules in their entirety.

According to the prior art, it is possible to mount side by side and/or stack one upon the other a great number of rear projection modules in a modular arrangement of an image projection wall, in order to represent a large-size image composed of many single partial images. The number of rear projection modules composed to form an image projection wall can be up to 150 or more.

Further details on rear projection modules are disclosed in document EP 0 756 720 B1 reference to which is made herewith.

Many commercially available projection apparatuses, for example video projection systems, use separate channels for each of the three primary colors. Such a system requires for each primary color an imaging device and optical paths which must converge onto the screen with pixel accuracy. Novel projection apparatuses use only one imaging device based on time-sequential additive color mixing, wherein the entire image is split into three single-colored partial images with regard to the primary colors red, green and blue. The imaging device is illuminated sequentially with the three primary colors. Therein, the image data to be represented is transferred to the imaging device according to the color that is just reaching the imaging device. The eye puts the colored partial images together to form a single full-color image. Likewise, the eye puts successive video images and partial video images together to form a full-motion image.

Such a system requires an apparatus for sequentially illuminating the imaging device with primary colors. The simplest apparatus of a dynamic color filter suitable for this purpose is a revolving color wheel serving to filter the color currently desired out of the white spectrum of an illumination unit.

Such color wheels for changing the color of the light coupled out by the projection lamp are, in general, produced from dichroic filters. Owing to their manufacture, however, the filters comprise deviations in their spectral filter characteristic manifesting themselves in differing filter edge positions. As a result, there are differences in the perception of the primary and mixed colors.

The imaging devices presently used in connection with time-sequential image generation are so-called Digital Micromirror Devices which are, for example, described in the patent publication U.S. Pat. No. 5,079,544. They comprise an arrangement of small moving mirrors for deflecting a light beam, either towards the projector lens (on) or away from the projector lens (off). By rapidly turning the pixels represented by the mirrors on and off, a gray scale can be achieved. The use of DMDs for the digitization of light is also known as DLP (digital light processing). A DLP projection system comprises a light source, optical elements, color filters, a digital control and formatting unit, a DMD, and a projector lens.

In many cases, high requirements are established for projection devices, more particularly for projection walls that are made up of a modular design with a plurality of projection devices; these requirements are only inadequately met by the prior art, due to the following technical causes:
The lamps used in the various projection apparatuses, which are high-power lamps in many applications, differ in their basic brightness. This requires work-intensive calibration of the individual projection devices, in order to achieve a uniform representation on a projection wall.
The luminous flux of the lamps that can be utilized for the projection apparatus changes during the lifetime of the lamps. Moreover, this ageing process depends on the particular lamps. This requires that the brightness of the projection apparatuses be calibrated repeatedly.
The tolerances of the lamps may result in different illumination distributions on the imaging device, which may also change during the ageing process of the lamps.
The spectral composition of the light emitted by the lamps discloses tolerances which require a color calibration of the projection devices.
The spectral composition of the light emitted by the lamps changes during the lifetime of the lamp. This requires repeated color calibration of the projection apparatuses.
Depending on the type of the gas discharge lamp used, the luminous flux is modulated over time, in order to stabilize the position of the discharge arc. This results in interferences in connection with time-sequential color mixing and, in addition, with the digitized generation of brightness stages (pulse-code modulation of a DMD). In order to suppress image artifacts resulting therefrom, the time-dependency of the luminous flux must be monitored.
Manufacturing tolerances of the other optical components also cause variations in the luminous flux on the projection area, for which reason the brightness of the projection apparatuses must be calibrated.

According to the prior art, these high technical requirements are solved by means of work-intensive methods which do not, however, solve the problems mentioned completely:
The lamps are selected to a high degree in order to overcome minimum manufacturing tolerances that cannot be fallen below further. This is work-intensive and very expensive.
While a projection apparatus or a projection wall is installed and/or when service work is carried out at regular intervals, the brightness and/or color are calibrated. Therein, the brightness distribution is measured on the screen and/or a color calibration is carried out by measuring the primary colors and the achromatic point on the screen. This is work- and cost-intensive and requires skilled personnel as well as an interruption in current operation. The image quality may become worse intermediate the service work intervals.
According to document U.S. Pat. No. 5,796,508, a sensor is used to verify the light reflected in the off state if the imaging device used is a DMD. This verification of the light in the off state must be forced by manipulating the image content. By forcing the off state, the visible image undergoes changes and/or interferences, so that continuous operation not disturbing the image content is not possible.
In order to verify the presence of stray light, a sensor is used outside of the optical path. However, stray light verification is to disadvantage in that the correlation between the measurement signal and the actual brightness of the image is inadequate. Due to the calibration error resulting therefrom, the modules of a projection wall still show visible differences in brightness.
Taking into consideration the mean change of the light output during the operating time, which is based on empirical values. However, the deviation of single lamps from a mean time-dependent change in light output is so strong that it will result in visible image artifacts unless it is corrected for the individual lamps.
Determination of the luminous flux by measuring the lamp power by means of an electric measurement of both lamp current and lamp voltage. But the percentage of lamp drivers available permitting such an electric measurement is only small, and the electric power of the lamps is not completely correlated with the resulting luminous flux of the projector.
Manual user input of a time-dependent change in the luminous flux, which must be taken into consideration. However, this requires that the user be trained appropriately and that special image contents be applied, this disturbing continuous operation.
Color correction by controlling the lamp power according to document WO 95/11572, in order to stabilize the optical power of the projector. Such a control of lamp power means that the lamp would be operated with a varying electric power. In the usually used high-power gas discharge lamps, this results in an undesired change in the shade and a shortened lamp life; this is to particular disadvantage if it is intended to use the lamps continuously in projection walls.

Document DE 198 19 245 C1 discloses a video projector wherein two deflecting mirrors are arranged between the light source and the imaging device and a rod-type light mixing system is arranged between the two deflecting mirrors. It comprises a dynamic color filter for time-sequential mixing of primary colors. Brightness or color calibration is not provided in this known apparatus.

Document U.S. Pat. No. 6,422,704 B1 discloses a projector with three dichroic mirrors, each with an associated imaging device. In order to calibrate the projector, a semi-transparent mirror can be swiveled into the light path between the lamp and the imaging device, wherein said semi-transparent mirror couples light, that is reflected from the projection wall and strayed back toward the lamp through the projection lens and the imaging device, onto a sensor which utilizes the intensity of this reflected light for setting purposes. Since the optical components are run through repeatedly, the measurement data thus obtained require work-intensive numeric corrections so that, with the usual manufacturing tolerances taken into consideration, the measurement accuracy achieved is limited to an extreme extent. Moreover, the reflectivity of the screen must be known, so that it is not possible to use any projection screens desired. Furthermore, it is not possible to use the known method during running operation of the projector.

Document WO 95/11572 discloses a projector with a color wheel. A signal generator controls the lamp current wherein the latter is synchronized with the position of the color segments of the color wheel. The lamp currents are manually calibrated by the user. In other words, the setting is made only once. It is not provided that the luminous flux of the color segments is monitored and controlled continuously.

With this prior art taken into consideration, the invention aims at providing a satisfactory solution for the brightness and/or color calibration of the aforementioned projection apparatuses. This problem is solved by the invention by means of a projection apparatus comprising the features of the appended independent apparatus claim and by means of a method comprising the features of the appended independent method claim. Preferred embodiments and further developments of the invention result from the dependent claims and the description following below including the related drawings.

A projection apparatus according to the invention, provided for projecting an image onto a projection screen, thus comprises an imaging device that can be controlled pixel by pixel and is provided for representing the image at a reduced scale, an illumination unit for illuminating the imaging device, and a projection assembly that comprises a projection lens and is provided for presenting the image represented by the imaging device enlarged on the projection screen, wherein the illumination unit comprises a dynamic color filter for generating primary colors, and, according to the invention, said projection apparatus is characterized in that it comprises an optical outcoupling element for coupling out a part of the luminous flux generated by the illumination unit for illuminating the imaging device, a sensor for measuring the intensity of the light coupled out by the outcoupling element, wherein the intensity measured by the sensor is a measure for the illumination level of the imaging device, and that it comprises a control unit which is used to control the brightness and/or color of the projected image by controlling the imaging device or by controlling the quantity of illumination light in relation to the signal of the sensor, wherein the outcoupling element couples light out of the light path on its way from the illumination unit to the imaging device.

A method according to the invention, provided for controlling the brightness and/or color of the projected image of a projection apparatus provided for projecting the image onto a projection screen, comprising an imaging device that can be controlled pixel by pixel and is provided for illuminating the imaging device, and a projection assembly that comprises a projection lens and is provided for presenting the image represented by the imaging device enlarged on the projection screen, wherein the illumination unit comprises a dynamic color filter for sequentially generating primary colors, and, according to the invention, is characterized in that, by means of an optical outcoupling element, a part of the luminous flux generated by the illumination unit for illuminating the imaging device is coupled out, the intensity of the light coupled out by the outcoupling element is measured by a sensor, wherein the intensity measured by the sensor is a measure for the illumination level of the imaging device, and that the imaging device is controlled or the quantity of illumination light is controlled by means of a control unit in a controlled manner and in relation to the signal of the sensor, wherein the outcoupling element couples light for the sensor out of the light path on its way from the illumination unit to the imaging device.

The invention permits to control the brightness and/or color of the image projected in a reliable and relatively easy manner that takes individual tolerances and ageing processes into consideration. The intensity determined by the sensor is supplied to the digital image processor which considers these values when controlling the imaging device, in order to achieve a uniform brightness and color.

The invention is to particular practical advantage in that the measurement can be performed continuously, thus facilitating a control loop with continuous control. It is to further advantage that it is not necessary to use additional measuring instruments or employ skilled personnel, because calibration can be achieved during running operation. For that reason, it is neither necessary to disturb or interrupt running operation; and even if use is made of illumination assemblies with a dual-lamp module intended to ensure uninterruptible operation in the event of a failure of one of the lamps by switching over to the second lamp, calibration can be carried out immediately.

The invention is to particular advantage in that the control unit allows to control the projected image during running operation of the projection apparatus, i.e. irrespective of the image content, without interrupting or disturbing running operation and without having to project a test pattern, and that the light must be measured on the illumination side of the imaging device only. This advantage is achieved particularly if the outcoupling element is arranged in the illumination path even when an image is projected onto a projection screen or if it is arranged permanently in the illumination path.

Thus, the invention allows to achieve goals already aimed at by those skilled in the art for a long time. In order to achieve particularly good results, preferred use is made of the measures described below, either separately or combined.

The imaging device preferably used in time-sequential additive color mixing is a Digital Micromirror Device (DMD). It is, however, also possible to use other imaging devices within the scope of the invention, for example the aforementioned imaging devices.

Preferably, the dynamic filter for time-sequential generation of primary colors is a color wheel. Other appropriate apparatuses available at the moment or in the future may, however, also be used within the scope of the invention.

In order to achieve a homogeneous or homogenized illumination it is preferred that the projection apparatus comprises a spatial light mixing system for compensating local differences in brightness distribution. Herein, preferred use is made of a spatial light mixing system which extends in the direction of light propagation, in particular of a light mixing rod. Light mixing rods are known according to the prior art. For example, known embodiments comprise hollow mixing rods (refer e.g. to U.S. Pat. No. 5,625,738) and solid mixing rods (refer e.g. to DE 10103099 A1).

Further preferred embodiments are characterized in that the outcoupling element is arranged in the illumination path between the illumination assembly and the imaging device, preferably between the output of the spatial light mixing system and the imaging device. This is the place most favorable for obtaining the necessary information on the intensity and spectral composition of the light.

There are various ways of implementing the outcoupling element. An advantageous embodiment is a semi-transparent, preferably color-neutral mirror which, to avoid high light losses, couples out a portion of the light to the sensor, advantageously less than 5 percent and preferably less than 2 percent.

The sensor may be a simple sensor which provides a mere brightness signal containing an integral information on the illumination of the imaging device. In other embodiments, a sensor with a two-dimensional local resolution may be provided for obtaining information on the homogeneity of the illumination of the imaging device or a sensor with spectral resolution may be provided for obtaining spectral information. All of the three sensor designs may be synchronized with the dynamic color filter for separating the primary color portions.

The invention will be illustrated in more detail below by means of an exemplary embodiment shown in the figures. The special features described therein can be used separately or combined, in order to create preferred embodiments of the invention. In the figures

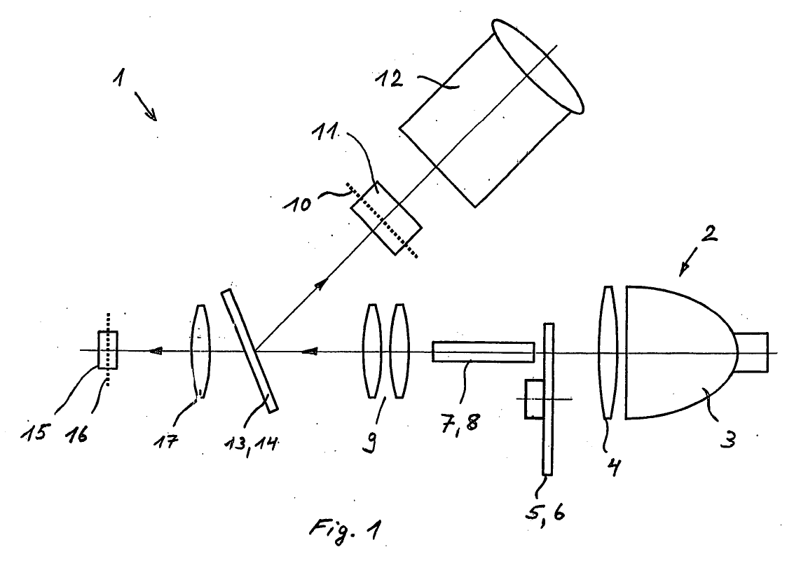

FIG. 1 is a schematic representation of components of a projection apparatus according to the invention;

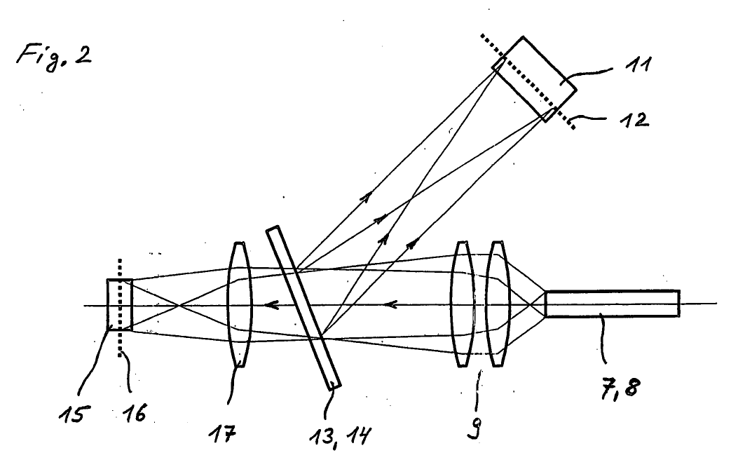

FIG. 2 shows details of FIG. 1;

FIG. 3 shows a modification to FIG. 2;

FIG. 4 shows a TIR prism without retroreflection;

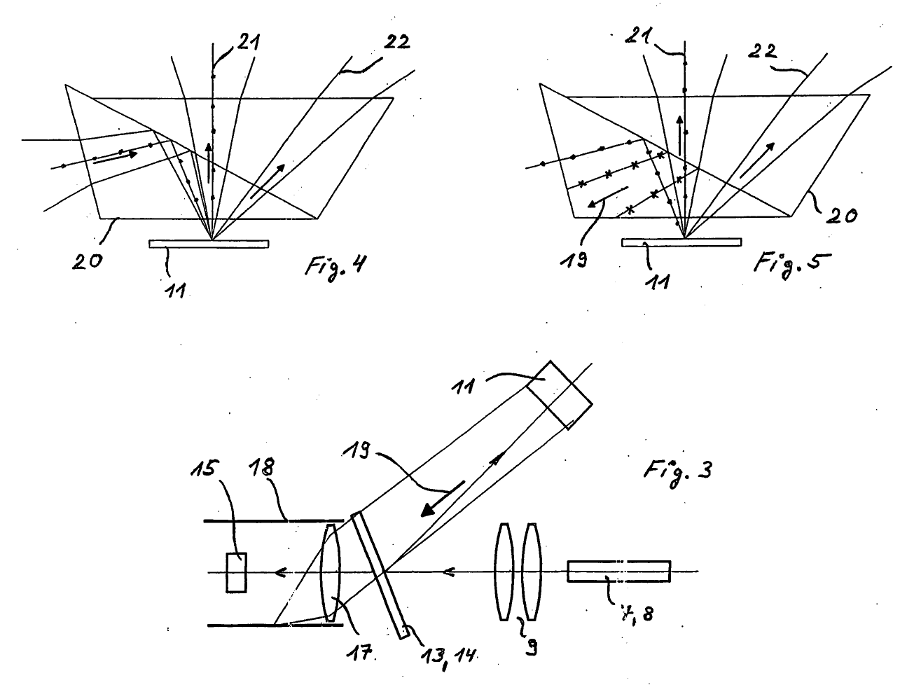

FIG. 5 shows a TIR prism with retroreflection;

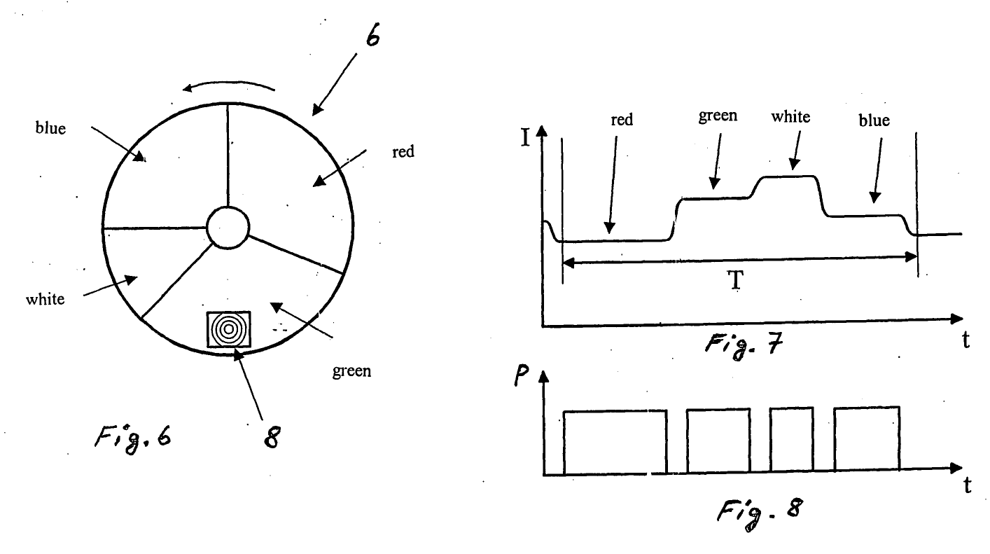

FIG. 6 shows a color wheel;

FIG. 7 shows the time course of the sensor signals relating to FIG. 6;

FIG. 8 shows the sensor control pulses relating to FIG. 7;

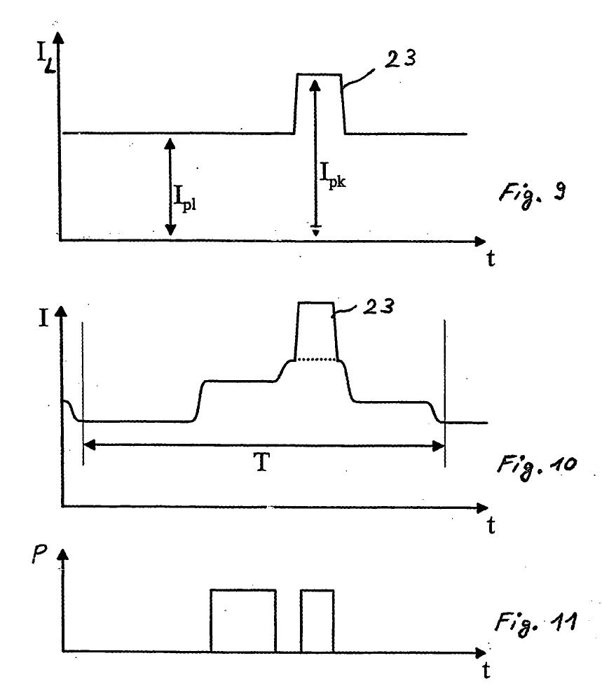

FIG. 9 shows the time course of the intensity of a gas discharge lamp with stabilization pulse;

FIG. 10 shows the time course of the sensor signal relating to FIG. 9; and

FIG. 11 shows the sensor control pulses relating to FIG. 10.

FIG. 1 shows the optical components of a projection apparatus 1 according to the invention. It comprises an illumination unit 2 with a lamp 3 provided as light source, preferably a gas discharge lamp, and a condenser system 4. The components which follow in the light path are a dynamic color filter 5 in the form of a color wheel 6 and a spatial light mixing system 7 in the form of a light mixing rod 8 extending in the direction of light propagation. The light exiting from the light mixing rod 8 is imaged onto the illumination plane 10 of an imaging device 11 by means of an imaging optics 9, which is also referred to as relay optics.

A projection lens 12 of a projection assembly forms an enlarged image of the image generated by the imaging device 11 on a projection screen (not shown), i.e. the image transmissively or reflectively generated by the imaging device 11 is projected onto a projection screen (not shown). In a preferred case of application of the invention, the projection apparatus 1 is a rear projection apparatus and the image projected by the projection lens 12 is a partial image of a projection wall containing a plurality of projection apparatuses or rear projection apparatuses.

The image projected is made up of successive monochrome partial images of the primary colors red, green and blue, utilizing the method of time-sequential mixing. The sequence may also contain a forth black-and-white partial image which is admixed to increase the brightness of the image. The sequence of partial images is effected at an adequately high speed, with the result that the eye cannot follow the color change and the colors are mixed physiologically.

The color wheel 6 serves to generate the primary colors red, green and blue from the white light of the lamp 3, in order to illuminate the imaging device 11. Preferably, the imaging device 11 is a DMD. If synchronized appropriately, the imaging device 11 can generate the monochrome partial images which are put together by the eye of the person viewing the image projected.

The light of the lamp 3 is focused to the input of the light mixing rod 8 by means of the condenser system 4. The revolving color wheel 6 comprises differently colored segments in the primary colors; depending on the revolving position of the color wheel 6, said segments transmit the spectral portions of the lamp 3 according to the color filter just present in the light path. The light mixing rod 8 ensures a homogeneous illumination, and the imaging optics 9 images the light distribution at the output of the light mixing rod 8 onto the imaging device 11.

The basic brightness of the image projected, i.e. the brightness of an image with fully white image contents, depends on the luminance at the location of the imaging device 11. Due to the aforementioned problems, it is therefore desired to know the luminance at the location of the imaging device 11. Furthermore, the ageing processes of the lamp 3 cause shifts in the intensity ratios among the spectral portions of the primary colors. As a result, the shade of the white mixed color changes in the course of time, i.e. during a time period of several hours or days. For that reason, the invention also aims at measuring the spectral composition of the light and a correction of the color mixture derived therefrom, in order to ensure that an effective offset of the achromatic point cannot be detected. Either aspect can be achieved with the embodiment according to the invention of a projection apparatus 1.

For this purpose, the invention provides an optical outcoupling element 13 for coupling out a part of the luminous flux generated by the illumination unit 3 for illuminating the imaging device 11, wherein the outcoupling element couples light for the sensor 15 out of the light path on its way from the illumination unit 2 to the imaging device 11. Preferably, the outcoupling element 13 is arranged in the illumination path between the lamp 3 and the imaging device 11, particularly between the output of the spatial light mixing system 7 and the imaging device 11. According to FIG. 1, the outcoupling element 13 is a semi-transparent, preferably color-neutral mirror 14, coupling out a portion of the light, advantageously less than 5 percent and preferably less than 2 percent. Thus, the transmittance is advantageously less than 5 percent and preferably less than 2 percent while the reflectivity is advantageously greater than 95 percent and preferably greater than 98 percent.

The light coupled out by the mirror 14 is measured by a sensor 15, so that the intensity measured by the sensor 15 is a measure for the illumination level of the imaging device 11. Thus, the signal of the sensor 15 can be supplied to a control unit which is used to control the brightness of the projected image by controlling the imaging device 11 in relation to the signal of the sensor 15. If the sensor 15 is synchronized with the respectively active color segments of the color wheel 6, it is also possible to measure the intensity of the primary colors. This information will then be provided to the electronics of the projection apparatus 1, and appropriate algorithms can be used to correct the color mixture on the basis of the measurement signal of the sensor 15. If the spectral composition of the light emitted by the lamp 3 changes, an offset of the achromatic point of the image projected can, therefore, actually, not be detected.

However, the control unit does not only permit control of the imaging device 11. It can, alternatively or additionally, also be provided that the control unit controls the quantity of illumination light in relation to the signal of the sensor 15 in a different manner. To achieve this, any of the known and appropriate methods can be used.

A particularly advantageous embodiment for controlling the quantity of illumination light is characterized in that use is made of a variable intensity reducer which is arranged in the immediate vicinity of the focal plane of a focusing lamp reflector. Further details of this embodiment are described in the applicant's international, simultaneously submitted patent application (title “Brightness control of a projection appliance”, attorney reference SEC 109/0A/WO), the full contents of which are incorporated by reference in this respect.

In order to achieve a basic setting or basic calibration of the projection apparatus 1, it can be provided that output values of the spectral properties of the illumination source or the lamp 3 of the illumination unit, of the dynamic color filter 5 and the sensor 15 and, if necessary, of the spatial light mixing system 7, the imaging lens 9 and the optical outcoupling element 13 are measured and considered by the control unit. Such a measurement of output values can, for example, be taken while the projection apparatus 1 is installed, while a service measure is carried out, or while a lamp is exchanged.

In order to achieve as high a correlation as possible of the spatial light distribution at the sensor 15 and the illumination plane 10 of the imaging device 11, it is proposed according to an advantageous feature that the sensor 15 is arranged in an optical plane that corresponds with the illumination plane 10 of the imaging device 11, i.e. that the illumination plane 10 of the imaging device 11 and the illumination plane 16 of the sensor 15 correspond optically with each other, wherein they contain the image of the output of the spatial light mixing system 7 according to an additional preferred feature.

The easiest solution to realizing these features would be to position the sensor at the same optical distance from the mirror 14 as the imaging device 11. In order to achieve a more compact setup of the projection apparatus 1, a sensor optics 17 is provided according to an additional preferred feature. It has a positive refractive power and generates a reduced image of the output of the light mixing rod 8 with shortened optical running length. Furthermore, this allows to adjust the image size of the light mixing rod 8 to the size of the sensor 15, so that a reduced image of the illumination pattern of the imaging device 11 is generated on the sensor 15.

FIG. 2 shows details of the light path shown in FIG. 1. If the sensor 2 is a simple and unstructured sensor supplying a brightness signal, it can be used to measure the integral brightness and the integral spectral composition of the light. If, however, use is made of a sensor 15 with local resolution, e.g. a CCD, it is also possible to measure the homogeneity of illumination, i.e. the homogeneity of the brightness of the image projected onto the screen. According to a different or additional embodiment, the sensor 15 can also be a sensor with spectral resolution.

FIG. 3 shows a setup corresponding to that shown in FIG. 2, additionally comprising a shielding 18 surrounding the sensor 15. In order to allow smooth functioning of the sensor 15 and of the control of the imaging device 11 derived from the signals of the sensor, it is to advantage if the signal verified by the sensor 15 is independent of external influences, such as ambient light, to the highest extent possible. This can be achieved by the shielding 18. In addition, independence of the image content currently projected is also required.

This requirement, however, is not met automatically, as can be seen from the example of an imaging device 11 in the form of a DMD with a TIR prism 20 shown in FIGS. 4 and 5. TIR stands for “Total Internal Reflection”; more detailed information is provided in document U.S. Pat. No. 5,552,922. The TIR prism 20 serves to easily separate incident light spatially from light that is reflected by the DMD. Therein, both components are separated by the total reflection occurring in the lower prism. The incident light is reflected totally, while the light reflected by the DMD just fails to meet the requirement for total reflection. It transmits optical aberrations through the second partial prism for compensation purposes.

The transmission of the ON state 21 through the two boundary surfaces at the air gap between the two halves of the prism is, however, always associated with Fresnell losses, despite the antireflective coating. That means that a part of the light of the ON state 21 is reflected back towards the light mixing rod 8. This effect, however, is far weaker for the OFF state 22 for geometrical reasons and due to the fact that the angles occurring between the direction of the light and the boundary surface are spaced apart from the angle of total reflection by a considerably longer distance than is applicable to the ON state 21. That means that the Fresnell losses are lower.

Hence, the retroreflected quantity of light depends on the image content; if the image is dark, the quantity of light retroreflected is lower; if the image is light, the quantity of light retroreflected is higher. Comparable retroreflections 19 may also occur with other types of imaging devices, for example with liquid-crystal displays.

If the sensor 15 in FIG. 3 were arranged in the immediate vicinity behind the mirror 14 without a sensor optics 17 being connected in series, it would not be possible to separate the light that is extending in forward direction from the retroreflections 19. In this case, the sensor optics 17 serves not only to image the light mixing rod 8 onto the sensor 15 but, together with the shielding 18, also to suppress interferences of the sensor 15 caused by retroreflections 19 from the imaging device 11. Therein, the sensor optics 17 images the retroreflections 19 to a place outside of the sensor 15 and absorbs same.

The setup of a projection apparatus 1 according to the invention described so far results in a measurement signal of the sensor 15 that changes synchronously with the rotation of the color wheel 6. This must be attributed to the sensitivity of the sensor 15 that varies for the different primary colors. FIG. 6 illustrates a typical color wheel 6 for a DMD or DLP projection apparatus with a typical red-green-white-blue color wheel sequence. The position of the input of the light mixing rod 8 on the color wheel 6 and the illumination of the light mixing rod 8 are also shown in FIG. 6.

Therein, the colors red and blue typically result in a weaker signal, while white yields the strongest signal. In the transitional region between the individual segments of the color wheel 6, the signal falls or rises towards the next signal level respectively. FIG. 7 shows the course of the sensor signal I as a function of the time t during a time period T of the color wheel 6. The edge slope resulting therefrom depends on the optical design of the projection apparatus, i.e. on the distance of the color wheel 6 from the focal point and on the size of the focal point.

In order to avoid an undefined evaluation of the signals of the sensor 15, it is to advantage to activate the sensor 15 always during one segment of the color wheel 6 only, i.e. to control the sensor 15 by means of a clock signal of the dynamic color filter 5 such that said sensor 15 determines the light intensities pertaining to the primary colors and possible color-neutral portions separately. This can be achieved by defining time measurement windows which suppress the amount contributed by a plurality of segments and by the transitional regions. This is permitted by a gate and delay electronics which, in turn, is synchronized by the clock generator of the color wheel 6 or the dynamic color filter 5. In this manner, it is possible to generate the sensor control pulses P shown in FIG. 8 which are running synchronously with the occurrence of the appropriate color segments.

According to a further advantageous feature, it can be provided that the intensity of the light generated by the illumination unit 2 can be varied over time and that this variation over time is considered and registered in the evaluation of the signals of the sensor 15. Such a variation in the intensity over time can, for example, be is caused by a stabilization pulse supplied to the lamp 3 of the illumination unit 2 so that the change in intensity of the lamp 3 caused by the stabilization pulse is registered by means of the sensor 15 and taken into consideration in the control unit.

It is, in particular, known for gas discharge lamps that the lamp driver is used to trigger a short increase in the lamp current. Typically, this is achieved with a pulse rate ranging from 50 to 250 Hz which is, thus, not visible in the image projected. The stabilization pulses serve to stabilize the local position of the discharge arc in the gas discharge lamp and, thus, to stabilize the spatial brightness distribution of the image projected.

However, the duration of the stabilization pulses as well as their height or the change in intensity of the lamp they cause must be considered and corrected in the sequential image generation. When the color mixture is calculated, these parameters must be known to the imaging device 15 or its activation electronics, in order to ensure that they can be considered and corrected.

In the most cases in practice, however, there arises the problem that the only defined variable is the duration of the stabilization pulse within tight variation limits. The change in intensity of the lamp 3 that is triggered by the stabilization pulses is, however, subject to greater variations caused in the technical production process and reveals a marked change during the ageing process of a lamp 3. This results in the necessity of a continuous measurement of the peak intensity Iₚₖ of the lamp 3 in relation to the plateau intensity Iₚₗ of the lamp 3 outside of a stabilization pulse.

FIG. 9 shows how the intensity I_{L} of the lamp 3 changes while a stabilization pulse 23 is applied. Correspondingly, FIG. 10 illustrates the change in the sensor signal I. Therein, it is assumed that the stabilization pulse 23 is synchronized with the rotation of the color wheel 6, so that the stabilization pulse 23 appears precisely in the color-neutral white segment. Owing to the increased light intensity, the sensor signal I reveals at the respective position a rise as compared with the signal that would be produced without the stabilization pulse 23.

A continuous measurement of the ratio of Iₚₖ/Iₚₗ during a prolonged time period of the ageing of the lamp 3, for example at an interval of hours or days, can now be achieved, for example, by the measurements of the sensor signals I during the green segment and during the stabilization pulse 23. This results in Iₚₖ/Iₚₗ=k·I_{WhitePulse}/I_{green}, wherein the constant k=I_{green}/I_{white} is defined once with the same time measurement windows but without the stabilization pulse 23. It contains the spectral sensitivity of the sensor 23 as well as the spectral properties of the color wheel 6 and of the remaining optical components.

The information obtained in this manner can consider the control unit for controlling the imaging device 11, in order to achieve a uniform brightness and/or constant color locus. This provides a more accurate value as compared with a value for influencing the stabilization pulse 23, which is known and predefined according to the prior art.

### LIST OF REFERENCE NUMBERS

1 Projection apparatus
2 Illumination unit
3 Lamp
4 Condenser system
5 Dynamic color filter
6 Color wheel
7 Spatial light mixing system
8 Light mixing rod
9 Imaging optics
10 Illumination level relating to 11
11 Imaging device
12 Projection lens
13 Optical outcoupling element
14 Mirror
15 Sensor
16 Illumination level relating to 15
17 Sensor optics
18 Shielding
19 Retroreflections
20 TIR prism
21 ON state
22 OFF state
23 Stabilization pulse
I Sensor signal
I_{L} Lamp intensity
Iₚₖ Peak intensity
Iₚₗ Plateau intensity
P Sensor control pulse
T Time period
t Time

1. A projection apparatus for projecting an image onto a projection screen, comprising
an imaging device that can be controlled pixel by pixel and is provided for representing the image at a reduced scale,
an illumination unit for illuminating the imaging device, and
a projection assembly comprising a projection lens and provided for imaging the image represented by the imaging device enlarged on the projection screen, wherein
the illumination unit comprises a dynamic color filter for time-sequential mixing of primary colors,
a spatial light mixing system for compensating local differences in brightness distribution,
an optical outcoupling element for coupling out a part of the luminous flux generated by the illumination unit for illuminating the imaging device, and
a sensor for measuring the intensity of the light coupled out by the optical outcoupling element, wherein the intensity measured by the sensor is a measure for the illumination level of the imaging device,
characterized in that
the outcoupling element is arranged in the illumination path between the illumination unit and the imaging device, wherein the outcoupling element is arranged between the output of the spatial light mixing system and the imaging device,
the outcoupling element couples light out of the light path on its way from the illumination unit to the imaging device, wherein the outcoupling unit couples light out of the light path on its way from the output of the light mixing system to the imaging device, and
the projection apparatus comprises a control unit which is used to control the color of the projected image by controlling the imaging device or by controlling the quantity of illumination light in relation to the signal (I) of the sensor.

2. A projection apparatus according to claim 1, characterized in that the control unit is also used to control the brightness of the projected image by activating the imaging device or by controlling the quantity of illumination light in relation to the signal (I) of the sensor.

3. A projection apparatus according to claim 1 characterized in that the sensor is a sensor without spectral resolution, supplying a brightness signal that contains integral information on the illumination of the imaging device.

4. A projection apparatus according to claims claim 1, characterized in that the imaging device is a Digital Micromirror Device (DMD).

5. A projection apparatus according to claim 1 characterized in that the dynamic color filter is a revolving color wheel.

6. A projection apparatus according to claim 1, characterized in that the spatial light mixing system is a a light mixing rod, extending in the direction of light propagation.

7. A projection apparatus according to any one of the claim 1, characterized in that the optical outcoupling element is arranged in the illumination path even while an image is projected onto a projection screen in the illumination path.

8. A projection apparatus according to claim 1, characterized in that the outcoupling element is arranged permanently in the illumination path.

9. A projection apparatus according to claim 1 characterized in that the outcoupling element is a semi-transparent mirror.

10. A projection apparatus according to claim 1, characterized in that the optical outcoupling element couples out less than 5 percent, preferrably less than 2 percent of the light.

11. A projection apparatus according to claim 1, characterized in that the sensor is arranged in an optical plane which corresponds with the illumination plane of the imaging device.

12. A projection apparatus according to claim 1, characterized in that the corresponding planes contain an image of the output of the spatial light mixing system.

13. A projection apparatus according to claim 1, characterized in that it further comprises a sensor optics which is used to generate on the sensor a reduced image of the illumination pattern of the imaging device.

14. A projection apparatus according to claim 1, characterized in that the sensor is a sensor that supplies a brightness signal.

15. A projection apparatus according to claim 1, characterized in that the sensor is sensor with a two-dimensional local resolution.

16. A projection apparatus according to claim 1, characterized in that the sensor is a sensor with spectral resolution.

17. A projection apparatus according to claim 1, characterized in that the sensor is controlled by means of a clock signal of the dynamic color filter such that it determines the light intensities pertaining to the primary colors and possible color-neutral portions separately.

18. A projection apparatus 4 according to claim 1, characterized in that the intensity (I_{L}) of the light generated by the illumination unit can be varied over time and that this variation over time is considered in the evaluation of the signals (I) of the sensor.

19. A projection apparatus according to claim 1, characterized in that the variation in the intensity (I_{L}) is based on a stabilization pulse supplied to the lamp of the illumination unit and that the change in intensity of the lamp caused by the stabilization pulse is registered and considered by the sensor.

20. A projection apparatus according to claim 1, characterized in that it further comprises a shielding that surrounds the sensor and is used to suppress retroreflections from the imaging device to the sensor.

21. A projection apparatus according to claim 1, characterized in that, in order to control the quantity of illumination light, it comprises a variable intensity reducer which is arranged in the immediate vicinity of the focal plane of the condenser system or the focal plane of a focusing lamp reflector.

22. A projection apparatus according to claim 1, characterized in that the control unit can be used to control the projected image during running operation of the projection apparatus.

23. A projection apparatus according to claim 1, characterized in that the illumination unit comprises a gas discharge lamp.

24. A projection apparatus according to claim 1, characterized in that it is a rear projection apparatus.

25. A projection wall, comprising a plurality of projection apparatuses according to claim 1.

26. A method for controlling the color of a projected image of a projection apparatus that is provided for projecting an image onto a projection screen, comprising
an imaging device that can be controlled pixel by pixel and is provided for representing the image at a reduced scale,
an illumination unit for illuminating the imaging device, and
a projection assembly comprising a projection lens and provided for imaging the image represented by the imaging device enlarged on the projection screen, wherein
the illumination unit comprises a dynamic color filter for time-sequential mixing of primary colors,
a spatial light mixing system for compensating local differences in brightness distribution,
wherein an optical outcoupling element is used for coupling out a part of the luminous flux generated by the illumination unit for illuminating the imaging device, and
wherein a sensor a is used for measuring the intensity of the light coupled out by the optical outcoupling element, wherein the intensity measured by the sensor is a measure for the illumination level of the imaging device, characterized in that
the outcoupling element couples light for the sensor out of the light path on its way from the illumination unit to the imaging device, wherein the outcoupling element is arranged between the output of the spatial light mixing system and the imaging device,
the outcoupling element is used to couple light out of the light path on its way from the light mixing system to the imaging device, wherein the outcoupling unit couples light out of the light path on its way from the output of the light mixing system to the imaging device, and
a control unit is used to control the imaging device in a controlled manner and in relation to the signal (I) of the sensor or to control the quantity of illumination light.

27. A method according to claim 26, characterized in that it comprises an element of a projection apparatus.
